(19) United States
(12) Patent Application Publication
(10) Pub. No.: US 2014/0379321 A1
(43) Pub. Date: Dec. 25, 2014

(54) METHOD AND SYSTEM FOR SIMULATING POWER LINE CARRIER COMMUNICATION SYSTEM

(71) Applicant: AEROSPACE SCIENCE & INDUSTRY SHENZHEN (GROUP) CO., LTD., Shenzhen (CN)

(72) Inventor: Zhen Xu, Shenzhen (CN)

(21) Appl. No.: 14/375,025

(22) PCT Filed: Sep. 12, 2013
(86) PCT No.: PCT/CN2013/083418

§ 371 Date: Jul. 28, 2014

(30) Foreign Application Priority Data
Sep. 24, 2012 (CN) 201210358215.1

(51) Int. Cl. G06F 17/50; H04B 3/54

(52) U.S. Cl. CPC G06F 17/5009; H04B 3/54
USPC 703/14

(57) ABSTRACT

The present invention relates to the field of power line carrier communication simulation technology, and more particularly to a method and system for simulating power line carrier communication system. In the simulation model of the sending end and the simulation model of the receiving end constructed by the simulation method and system, each of the channel encoding model and the channel decoding model includes a simulation model of a ARM core chip and a peripheral logic circuit of the ARM core chip, the sending end includes a simulation model of a RS error correction encoding algorithm of the ARM core chip, and the receiving end includes a simulation model of a RS error correction decoding algorithm of the ARM core chip. Since the ARM core chip has strong data processing capability, and the cost of the ARM core chip is generally lower than the cost of a DSP chip or a FPGA chip, a RS cyclic error correction code algorithm with strong error correction capability can be achieved at a low cost by combining the ARM core chip with the RS error correction encoding and decoding algorithms which can ensure stable transmission of power line carrier signals.

### TECHNICAL FIELD

The present invention relates to the field of power line carrier communication simulation technology, and more particularly to a method and system for simulating a power line carrier communication system.

### BACKGROUND

Power line carrier (PLC) communication refers to a special communication manner for carrying out voice or data transmission using a power line as a transmission media. It is known to all, a carrier signal without being treated cannot be transmitted at a high speed and stably, because the power line carrier communication is affected by the following factors: 1) barrier effect of a distribution transformer to a carrier signal; 2) influence of interference between power lines to the carrier signal; 3) influence of a signal coupling manner (e.g., line-ground coupling, line-midline coupling, and the like) to the carrier signal; 4) influence of pulse interference of the power lines themselves to the carrier signal; 5) high cut off to the carrier signal because of impedance of the power line; 6) influence of high noise of the power lines to the carrier signal; 7) influence of distribution parameters of different distribution points of the power lines to the carrier signal. Therefore, each current power line carrier communication system includes a sending end and a receiving end with signal processing functions. The sending end is configured for coupling a carrier signal which is treated by channel encoding, modulating, and other processes to power lines, and the receiving end is configured for performing processes corresponding to a carrier signal transmitted by the power lines.

In the prior art, in one case, the sending end and the receiving end respectively use manners of combining a microprocessor chip with a programmable logic chip to achieve channel encoding/decoding of the carrier signal and channel modulation/demodulation of the carrier signal. Due to limitations of performances and development technology of the microprocessor chip, the microprocessor chip generally does not use complex communication algorithms to achieve channel encoding/decoding, and even in some cases, the microprocessor chip does not process the carrier signal, and the carrier signal is transmitted by a transparent transmission manner. In another case, the sending end and the receiving end respectively use a DSP chip or a FPGA chip instead of the microprocessor chip to achieve channel encoding/decoding for the carrier signal. Although the DSP chip or the FPGA chip have better performances and can employ complex communication algorithms to achieve channel encoding/decoding, due to their high cost, they are not suitable for wide popularization and application.

Generally, before the sending end and the receiving end of the power line carrier communication system are put into production, a software platform for simulating a power line carrier communication system needs to be constructed so as to simulate function units of the sending end and the receiving end and verify system functions according to data of simulation results. However, according to the aforementioned structure of the sending end and the receiving end in the prior art, the function module constructed for channel encoding/decoding is a microprocessor chip, a DSP chip or a FPGA chip, which has the problem of poor processing ability to the carrier signal or high product cost.

### SUMMARY

The present invention provides a method for simulating a power line carrier communication system aiming to solve the problem in the prior art that the function module constructed for channel encoding/decoding is a microprocessor chip, a DSP chip or a FPGA chip, which has the problem of poor processing ability to the carrier signal or high product cost.

The present invention provides a method for simulating a power line carrier communication system, the method includes:

S1. constructing simulation models of a sending end, a receiving end, and power line channels of a power line carrier communication system;

S2. sending test data to the constructed simulation model of the sending end, and obtaining and displaying simulation result data;

wherein the simulation model of the sending end includes a channel encoding model, the channel encoding model includes a simulation model of an ARM core chip and a peripheral logic circuit of the ARM core chip, and a simulation model of a RS error correction encoding algorithm of the ARM core chip; the simulation model of the receiving end includes a channel decoding model, the channel decoding model includes a simulation model of an ARM core chip and a peripheral logic circuit of the ARM core chip, and a simulation model of a RS error correction decoding algorithm of the ARM core chip.

The present invention also provides a system for simulating a power line carrier communication system, the system includes:

a simulation model constructing module configured for constructing simulation models of a sending end, a receiving end, and power line channels of a power line carrier communication system;

a simulation execution module configured for sending test data to the simulation model of the sending end constructed by the simulation model constructing module and obtaining and displaying the simulation result data;

wherein the simulation model of the sending end includes a channel encoding model, the channel encoding model includes a simulation model of an ARM core chip and a peripheral logic circuit of the ARM core chip, and a simulation model of a RS error correction encoding algorithm of the ARM core chip, the simulation model of the receiving end includes a channel decoding model, the channel decoding model includes a simulation model of an ARM core chip and a peripheral logic circuit of the ARM core chip, and a simulation model of a RS error correction decoding algorithm of the ARM core chip.

In the simulation model of the sending end and the simulation model of the receiving end constructed by the method and system for simulating a power line carrier communication system provided by the embodiments of the present invention, each of the channel encoding model and the channel decoding model includes a simulation model of an ARM core chip and a peripheral logic circuit of the ARM core chip, the sending end includes a simulation model of a RS error correction decoding algorithm of the ARM core chip , and the receiving end includes a simulation model of a RS error correction decoding algorithm of the ARM core chip. Because cost of the ARM core chips is generally lower than the cost of DSP chips or FPGA chips used in sending ends and receiving ends of conventional power line carrier communication systems, and a RS cyclic error correction code algorithm with strong error correction capability can be achieved at low cost by combining the ARM core chip with the RS error correction encoding and decoding algorithms. Meanwhile, the ARM core chip has strong data processing capability, and thus can handle the RS error correction encoding and decoding algorithm with strong error correction capability. In the combination of a microprocessor chip and a programmable logic chip used in a sending end and a receiving end of a conventional power line carrier communication system, since the data processing capability of the microprocessor chip is limited, the microprocessor chip cannot used as a hardware carrier of RS error correction encoding and decoding algorithms which can ensure stable transmission of power line carrier signal. In summary, the stable transmission of the power line carrier signal can be ensured at low cost by the combination of the ARM core chip and the RS error correction encoding and decoding algorithms, and of which the advantages are superior to the advantages of using a DSP chip, a FPGA chip or a microprocessor chip and the like, for example a singlechip, alone.

### BRIEF DESCRIPTION OF THE DRAWINGS

FIG. 1 shows a flow chart of a method for simulating a power line carrier communication system in accordance with an embodiment of the present invention;

FIG. 2 shows a structure diagram of a power line carrier communication system constructed by the method for simulating the power line carrier communication system in accordance with an embodiment of the present invention;

FIG. 3 is a structure diagram of a simulation model of the power line channel in the FIG. 2;

FIG. 4 shows a structure diagram of a system for simulating the power line carrier communication system in accordance with an embodiment of the present invention.

### DETAILED DESCRIPTION OF THE PREFERRED EMBODIMENTS

In order to make the purpose, technical solutions and the advantages of this application more clearly, the present invention will be explained below in detail referencing to the accompany drawings and embodiments. It should be appreciated that the embodiment(s) described following are merely to explain this application but is no way intended to limit the invention.

Aiming at the problems of the prior art, in the sending end and the receiving end constructed by the method for simulating a the power line carrier communication system provided by the embodiments of the present invention, function models constructed for channel encoding/decoding include a simulation model of an ARM core chip and a peripheral logic circuit, and a simulation model of RS error correction encoding algorithm and decoding algorithm of the ARM core chip.

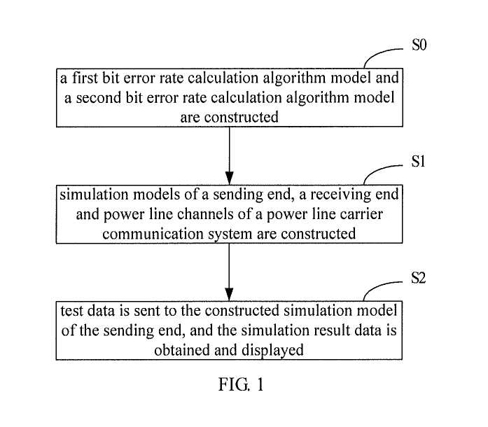

FIG. 1 shows a flow chart of a method for simulating the power line carrier communication system in accordance with an embodiment of the present invention.

In the step S1, simulation models of a sending end, a receiving end and power line channels of a power line carrier communication system are constructed. Preferably, in the embodiment, the simulation model of the sending end, the receiving end, and the power line channels of the power line carrier communication system are constructed by Matlab/Simulink.

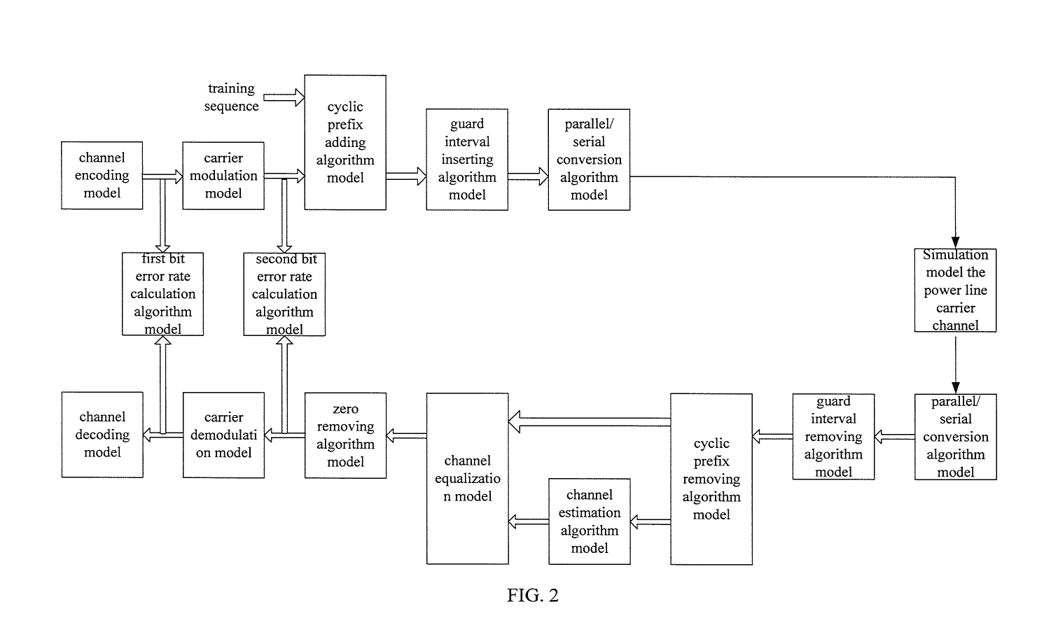

As shown in FIG. 2, the differences between the embodiment and the prior art are that: the simulation model of the sending end includes a channel encoding model, the channel encoding model includes a simulation model of an ARM core chip and a peripheral logic circuit, and a simulation model of a RS error correction encoding algorithm of the ARM core chip; the simulation model of the receiving end includes a channel decoding model, the channel decoding model includes a simulation model of an ARM core chip and a peripheral logic circuit, and a simulation model of a RS error correction decoding algorithm of the ARM core chip. Wherein the RS error correction decoding algorithm is an encoding algorithm based on the RS code, the RS code is also known as the Reed-Solomon codes, which has strong error correction capability and is easy to be constructed; wherein the ARM core chip has strong data processing capability, and the cost of the ARM core chip is generally lower than the cost of the DSP chip or the FPGA chip, a RS cyclic error correction code algorithm with strong error correction capability can be achieved at low cost by a combination of the ARM core chip and the RS error correction encoding and decoding algorithms which can ensure stable transmission of power line carrier signal.

Preferably, the ARM core chip is a STM32 chip, wherein the kernel of the chip is ARM Cotex-M3 and uses a Harvard structure, which can carry out fast fixed-point operation, has stronger data processing capability and costs less.

Wherein the simulation model of the sending end further includes: a carrier modulation model, the carrier modulation model including a simulation model of a PLC chip and a simulation model of the algorithm of the PLC chip; a cyclic prefix adding algorithm model coupled with the carrier modulation model; an guard interval inserting algorithm model coupled with the cyclic prefix adding algorithm model; and a parallel/serial conversion algorithm model coupled with the inserting guard interval algorithm model and simulation model of power line channels. Wherein the channel encoding model is configured for carrying out the RS encoding algorithm to the input carrier signal, the carrier modulation model is configured for modulating the encoded carrier signal, the cyclic prefix adding algorithm model is configured for adding a cyclic prefix to the modulated carrier signal, the guard interval inserting algorithm model is configured for inserting a training sequence, and the parallel/serial conversion algorithm model is configured for converting a plurality of bit data information into a single carrier signal by a transformation algorithm.

The constructed simulation model of the receiving end further includes: a parallel/serial conversion algorithm model coupled with the simulation model of power line channels; a guard interval removing algorithm model coupled with the parallel/serial conversion algorithm model; a cyclic prefix removing algorithm model coupled with the guard interval removing algorithm model; a channel equalization model coupled with the cyclic prefix removing algorithm model; a channel estimation algorithm model coupled between the cyclic prefix removing algorithm model and the channel equalization model; a zero removing algorithm model coupled with the channel equalization model; a carrier demodulation model coupled with the zero removing algorithm model; and a channel decoding model coupled with the carrier demodulation model, wherein the functions of the parallel/serial conversion algorithm model, the guard interval removing algorithm model, the carrier demodulation model and the channel decoding model correspond to the corresponding simulation model of the sending end respectively, so they do not need to be detailed here.

Furthermore, before or after the step S1, the method further includes a step S0: a first bit error rate calculation algorithm model and a second bit error rate calculation algorithm model are constructed. Wherein the first bit error rate calculation algorithm model is configured for coupling the channels between the channel encoding model and the carrier modulation model, and coupling the channels between the channel decoding model and the carrier demodulation model; the second bit error rate calculation algorithm model is configured for coupling the channels between the carrier modulation model and the cyclic prefix adding algorithm model, and coupling the channels between the carrier demodulation model and zero removing algorithm model.

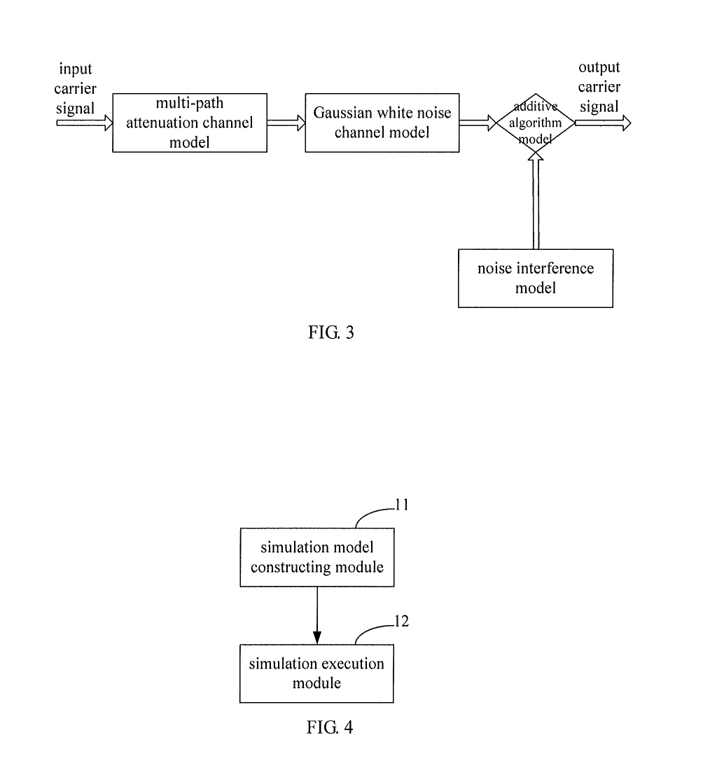

Moreover, as shown in FIG. 3, the constructed simulation model includes: a multi-path attenuation channel model; a Gaussian white noise channel model coupled with the multi-path attenuation channel model; a noise interference model; and an additive algorithm model coupled with the Gaussian white noise channel model and the noise interference model. The simulation model of the power line channel describes three kinds of most important interference characteristics of the power line channels, wherein a multi-path attenuation refers to a signal characteristic that the carrier signal reaches the receiving end through a number of different paths due to signal reflection and refraction caused by the paths or other factors during the signal transmission. Gaussian white noise refers to a class of noise, of which the amplitude obeys a Gaussian distribution and the power spectral density obeys uniformly distribution; an additive noise channel is composed of a noise interference channel and a Gaussian white noise channel, the additive noise channel has another type of noise, and the relationship of the noises are additive. Wherein the noise interference model of the power line carrier includes five common types of noise models as follow: a colored background noise model, a narrowband noise model, a periodic pulse noise model synchronous to the power frequency, a periodic pulse noise model asynchronous to the power frequency, and a random pulse noise model, wherein the colored background noise model can be generated by filtering the acoustic source of the Gaussian white noise by a filter. Wherein power frequency refers to the power frequency of commercial power, of which the size varies depending on the country; the power frequency is specified as 50 HZ in most countries, and in some countries it is specified as 60 HZ.

In the step S2, test data is sent to the constructed simulation model of the sending end, and the simulation result data is obtained and displayed. Wherein the specific steps of obtaining and displaying the simulation results are as follow: obtaining bit error rates of the carrier signals, total numbers of error symbols and total numbers of all the symbols calculated respectively by the first bit error rate calculation algorithm model and the second bit error rate calculation algorithm model; and identifying influence of the attenuation and noise on the carrier signals according to the calculated bit error rates when the carrier signals pass through simulation models of the power line channels.

FIG. 4 shows a structure diagram of a simulation system of the power line carrier communication system in accordance with an embodiment of the present invention, for convenience of description, only portions related to the embodiments of the present invention are shown.

A system for simulating a power line carrier communication system provided by the embodiment of the present invention includes: a simulation model constructing module 11 configured for constructing simulation models of a sending end, a receiving end, and power line channels of a power line carrier communication system; and a simulation execution module 12 configured for sending test data to the simulation model of the sending end constructed by the simulation model constructing module 11 and obtaining and displaying the simulation result data. Wherein each simulation model constructed by the simulation model constructing module 11 has been described above, the specific implementation process of the simulation execution module 12 has also been described above, so they do not need to be detailed here.

Further, the simulation model constructing module 11 also configured for constructing a first bit error rate calculating algorithm model and a second bit error rate calculating algorithm model, wherein the connection relationships of the first bit error rate calculation algorithm model and the second bit error rate calculation algorithm model with other models have been described above, so they do not need to be repeated here.

In the simulation model of the sending end and the simulation model of the receiving end constructed by the method and system for simulating the power line carrier communication system provided by the embodiments of the present invention, each of the channel encoding model and the channel decoding model includes a simulation model of an ARM core chip and a peripheral logic circuit of the ARM core chip, the sending end includes a simulation model of a RS error correction encoding algorithm of the ARM core chip, and the receiving end includes a simulation model of a RS error correction decoding algorithm of the ARM core chip. Because cost of the ARM core chip is generally lower than the cost of the DSP chips or the FPGA chips used in the sending ends and the receiving ends of conventional the existing power line carrier communication systems, so a RS cyclic error correction code algorithm with strong error correction capability can be achieved at low cost by the combination the ARM core chip with the RS error correction encoding and decoding algorithms. Meanwhile, the ARM core chip has strong data processing capability, and thus can handle the RS error correction encoding and decoding algorithm which has strong error correction capability. In the combination of a microprocessor chip and a programmable logic chip used in a sending end and a receiving end of a conventional power line carrier communication system, since the data processing capability of the microprocessor chip is limited, the microprocessor chip can not used as a hardware carrier of RS error correction encoding and decoding algorithms which can ensure stable transmission of power line carrier signal. In summary, the stable transmission of the power line carrier signal can be ensured at low cost by the combination of the ARM core chip and the RS error correction encoding and decoding algorithms, of which the advantages are superior to the advantages of using a DSP chip, a FPGA chip or a microprocessor chip and the like, for example a singlechip, alone. The skilled in the field can understand that all or part of the steps of the above-described embodiment of the method can be completed by controlling the relevant hardware by a program, and the program can be stored in a computer readable storage medium, such as a ROM/RAM disk, a CD-ROM, and the like.

The above-mentioned description is only a preferred embodiment of the present invention, which is not therefore limit the patent range of the present invention. Any equivalent structures or equivalent processes transform or the direct or indirect use in other related technical fields made by the specification and the figures of the present invention are similarly included the range of the patent protection of the present invention.

1. A method for simulating a power line carrier communication system, wherein the method comprises the following steps:
S1. constructing simulation models of a sending end, a receiving end, and power line channels of a power line carrier communication system;
S2. sending test data to the constructed simulation model of the sending end, and obtaining and displaying the simulation result data;
wherein, the simulation model of the sending end comprises a channel encoding model, and the channel encoding model comprises: a simulation model of an ARM core chip and a peripheral logic circuit of the ARM core chip, and a simulation model of a RS error correction encoding algorithm of the ARM core chip; the simulation model of the receiving end comprises a channel decoding model, and the channel decoding model comprises: a simulation model of the ARM core chip and a peripheral logic circuit of the ARM core chip, and a simulation model of a RS error correction decoding algorithm of the ARM core chip.

2. The method as claimed in claim 1, wherein, the simulation model of the sending end further comprises:
a carrier modulation model, the carrier modulation model comprises a simulation model of a PLC chip and a algorithm simulation model of the PLC chip;
a cyclic prefix adding algorithm model coupled with the carrier modulation model;
an guard interval inserting algorithm model coupled with the cyclic prefix adding algorithm model; and
a parallel/serial conversion algorithm model coupled with the guard interval inserting algorithm model and simulation model of power line channel.

3. The method as claimed in claim 2, wherein, the ARM core chip is a STM32 chip, and the simulation model of the receiving end further comprises:
a parallel/serial conversion algorithm model coupled with the simulation model of power line channel;
a guard interval removing algorithm model coupled with the parallel/serial conversion algorithm model;
a cyclic prefix removing algorithm model coupled with the guard interval removing algorithm model;
a channel equalization model coupled with the cyclic prefix removing algorithm model;
a channel estimation algorithm model coupled between the cyclic prefix removing algorithm model and the channel equalization model;
a zero removing algorithm model coupled with the channel equalization model;
a carrier demodulation model coupled with the zero removing algorithm model; and
a channel decoding model coupled with the carrier demodulation model.

4. The method as claimed in claim 3, wherein, the method further comprises:
S0: before or after step S1, constructing a first bit error rate calculation algorithm model and a second bit error rate calculation algorithm model;
wherein, the first bit error rate calculation algorithm model is configured for coupling channels between the channel encoding model and the carrier modulation model, and coupling channels between channel decoding model and the carrier demodulation model; and the second bit error rate calculation algorithm model is configured for coupling channels between the carrier modulation model and the cyclic prefix adding algorithm model, and coupling channels between the carrier demodulation model and zero removing algorithm model.

5. The method as claimed in claim 1, wherein, the simulation model of the power line channel comprises:
a multi-path attenuation channel model;
a Gaussian white noise channel model coupled with the multi-path attenuation channel model;
a noise interference model, the noise interference model comprises: a colored background noise model, a narrowband noise model, a periodic pulse noise model synchronous to the power frequency, and a periodic pulse noise model asynchronous to the power frequency, and a random pulse noise model; and
an additive algorithm model coupled with the Gaussian white noise channel model and the noise interference model.

6. A system for simulating a power line carrier communication system, wherein the system comprises:
a simulation model constructing module configured for constructing simulation models of a sending end, a receiving end and power line channels of a power line carrier communication system;
a simulation execution module, configured for sending test data to the simulation model of the sending end constructed by the simulation model constructing module and obtaining and displaying the simulation results data;
wherein, the simulation model of the sending end comprises: a channel encoding model, and the channel encoding model comprises: a simulation model of an ARM core chip and a peripheral logic circuit of the ARM core chip, and a simulation model of a RS error correction encoding algorithm of the ARM core chip; the simulation model of the receiving end comprises: a channel decoding model, and the channel decoding model comprises: a simulation model of an ARM core chip and a peripheral logic circuit of the ARM core chip, and a simulation model of a RS error correction decoding algorithm of the ARM core chip.

7. The system as claimed in claim 6, wherein, the simulation model of the sending end further comprises:
a carrier modulation model, the carrier modulation model comprises a simulation model of a PLC chip and a simulation model of the algorithm of the PLC chip;
a cyclic prefix adding algorithm model coupled with the carrier modulation model;
an guard interval inserting algorithm model coupled with the cyclic prefix adding algorithm model; and
a parallel/serial conversion algorithm model coupled with the guard interval inserting algorithm model and simulation model of power line channel.

8. The system as claimed in claim 7, wherein the ARM core chip is a STM32 chip, and the simulation model of the receiving end further comprises:
a parallel/serial conversion algorithm model coupled with the simulation model of power line channel;
a guard interval removing algorithm model coupled with the parallel/serial conversion algorithm model;
a cyclic prefix removing algorithm model coupled with the guard interval removing algorithm model;
a channel equalization model coupled with the cyclic prefix removing algorithm model;
a channel estimation algorithm model coupled between the cyclic prefix removing algorithm model and the channel equalization model;
a zero removing algorithm model coupled with the channel equalization model;
a carrier demodulation model coupled with the zero removing algorithm model; and
a channel decoding model coupled with the carrier demodulation model.

9. The system as claimed in claim 8, wherein the simulation model constructing module is further configured for constructing a first bit error rate calculation algorithm model and a second bit error rate calculation algorithm model;
wherein, the first bit error rate calculation algorithm model is configured for coupling channels between the channel encoding model and the carrier modulation model, and coupling channels between channel decoding model and the carrier demodulation model; the second bit error rate calculation algorithm model is configured for coupling channels between the carrier modulation model and the cyclic prefix adding algorithm model, and coupling channels between the carrier demodulation model and zero removing algorithm model.

10. The system as claimed in claim 6, wherein, the simulation model of the power line channel comprises:
a multi-path attenuation channel model;
a Gaussian white noise channel model coupled with the multi-path attenuation channel model;
a noise interference model,
the noise interference model comprises: a colored background noise model, a narrowband noise model, a periodic pulse noise model synchronous to the power frequency, and a periodic pulse noise model asynchronous to the power frequency and a random pulse noise model; and
an additive algorithm model coupled with the Gaussian white noise channel model and the noise interference model.
